(19) United States
(12) Patent Application Publication
(10) Pub. No.: US 2017/0335820 A1
(43) Pub. Date: Nov. 23, 2017

(54) HYDRAULIC MACHINE WITH IMPROVED OSCILLATING AXIAL CYLINDERS

(71) Applicant: MONEY S.R.L, Modena (IT)

(72) Inventor: Felice PECORARI, Modena (IT)

(21) Appl. No.: 15/524,972

(22) PCT Filed: Nov. 9, 2015
(86) PCT No.: PCT/IB2015/002082

§ 371 Date: May 5, 2017

(30) Foreign Application Priority Data
Nov. 8, 2014 (IT) MO2014A000327

(51) Int. Cl. F03C 1/40; F03C 1/32; F04B 1/20; F03C 1/06; F04B 1/32; F04B 1/22

(52) U.S. Cl. CPC F03C 1/0686; F04B 1/328; F04B 1/22; F04B 1/2092; F03C 1/0639; F03C 1/0673; F03C 1/0652; F04B 1/2035

(57) ABSTRACT

A hydraulic machine with oscillating axial cylinders includes a plurality of oscillating axial cylinders, put in synchronous rotation between a first rotating element, a rotating disc, which supports one end of the cylinder, bottom or piston, and a second rotating element, a rotating barrel, which supports the opposite end of the cylinder; each cylinder is connected to said rotating elements with a ball joint towards each of them; each ball joint is holed to allow for the passage and the feeding/discharge through it of the hydraulic liquid. At least the bottom or the piston is connected to the respective rotating element with a ball joint having a spherical surface with a diameter equal to or greater than the cylinder bore.

### FIELD OF THE INVENTION

The present invention relates to a hydraulic machine with oscillating axial cylinders, that is to say, a machine which generates pressurized hydraulic fluid, as pumps, or transforms the pressurized hydraulic fluid into mechanical driving rotational motion, as motor, in the known open-circuit or closed-circuit hydrostatic transmissions, and wherein the axial hydraulic cylinders, which can oscillate freely, are improved in such a way as to make the operation of the machine more reliable and to make it possible to realize new sizes of the machine, as well as significant improvements in the efficiency and duration of the hydraulic machine.

### PRIOR ART

The state of the art comprises various types of hydraulic machines, pumps and motors, with an axial arrangement of the cylinders, gathered in a rotating barrel, angled with respect to the rotational axis in such a way as to move the pistons in the cylinders and realize the displacement of the machine. In the past decades several experimentations and realizations have been made on this setting and the most convenient embodiment found in the art was the realization of the curved liners in which the pistons are put to accomplish a curvilinear trajectory, for the different position reached in the evolution within the barrel and for the inclination of the pad, on which the pistons are fixed, connected to each other and rotating synchronously.

Moreover, in the art, as described in the prior art document WO 9622463, such a setting was hard to realize because the position of the piston, in accomplishing the curved trajectories imposed by the curve of the liners in the rotating barrel, differs from the effective position that the piston, rigidly connected to the rotating pad, assumes at the different angles corresponding to the displacement values which the mechanism is called to develop in its motion. That is to say, the curves and the trajectories are not perfectly spherical in the evolution of the pistons, but they differ in trajectory corrections of higher order, which are infinitesimal but do not allow for a safe and long-lasting operation in addition to the short experimentation moment. In fact, the realization of hydraulic machines described in the above-mentioned document has not been industrially possible due to the difficulty of realization, in a safe and long-lasting way, of the correct curved liner-piston coupling in the various angles which a pad can assume with respect to the corresponding barrel with curved liners and rotating with it.

In order to overcome this technical problem, other mechanisms of support and oscillation of the axial cylinders of a hydraulic machine have been developed in the art, as described for example in the document WO 2013/067666 in which a series of hydraulic axial cylinders are put in rotation on a shaft, with the respective bottom connected to a rotating flange and coupled to it with a sleeve having a spherical head coupled on the internal cylindrical surface of the cylinder; the piston, too, has a spherical coupling between the stem and the piston itself, or even the ball constitutes the piston itself, in such a way as to make the respective cylinder oscillating, on the two spherical couplings during the synchronous rotations of the stems of the pistons. The stems of the pistons are connected on a pad, which is inclined with respect to the axis of the rotation shaft of said flange, to transmit the stroke of the pistons within the cylinders. The oscillation of the cylinder is free and driven by the two spherical couplings, thus overcoming the problems of combinations of curves present in the art.

This described realization, although it makes the axial cylinders oscillating in a free way, does not allow to obtain an articulated joint of the bottom of the cylinder which realizes a sealing of the hydraulic liquid pressure intrinsic with the constitution of the articulated joint itself; that is to say, the various represented modes of spherical connection in the bottom of the oscillating axial cylinder or even of the spherical connection in the piston, between the stem of the piston and the piston itself, do not allow for a self-reinforced seal from the hydraulic liquid pressure. In fact, in the description of the realization of the bottoms of the cylinders sealing rings are always used, which operate on the ball of me articulated joint or bottoms made of a material softer than the material of the barrel and consist of two parts at the assembly of the articulated joint. Therefore, the various solutions of construction, of assembly and sealing of a bottom or the coupling of the stem with the piston, do not allow for the safe and long-lasting operation of the ball joint couplings which, performing evolutions at every rotational turn of the shaft at the minimum or at the maximum displacement, are always stressed in the same point by the centrifugal force acting on the free masses of the piston and above ail of the cylinder. This causes an anomalous consumption due to wear, although the surfaces are in contact in the presence of the hydraulic liquid which has, as it is known, lubricating characteristics as well, causing the spherical coupling to draw more, thus reducing the volumetric efficiency of the hydraulic machine, and increasing the noise and in conclusion making it less efficient. Therefore, the hydraulic sealing of the piston in the barrel of the cylinder is associated with the contact of the ball with the surface of the barrel, or, made introducing the piston permanently in the barrel of the cylinder, to reduce the drawer effect which is determined with the ball joint of the piston external to the barrel of the cylinder.

As stated above, in order to solve said drawback, solutions of assembly of the spherical coupling of the piston have been proposed, as described in the document WO 2013/143860, by means of a gasket housed on the spherical surface of the piston in a circumferential hollow, lying on a plane perpendicular to the stem, in this way the thrust of the hydraulic liquid is exactly aligned with the stem, but the sealing capability of the gasket is jeopardized due to the different curve in the operating evolutions which the circumferential hollow has with respect to the internal cylindrical surface of the cylinder facing it, that is to say, the adjustment of the different curves for the sealing in the ball joint of the piston still remains unsolved.

This state of the art is susceptible of significant improvements with respect to the possibility of realizing a hydraulic machine with oscillating axial cylinders, which overcomes the above-mentioned drawbacks realizing a considerable improvement in its duration and efficiency.

Therefore, the technical problem, which is at the basis of the present invention, is to realize an articulated joint for an oscillating axial cylinder which, although being simple and economical in its realization, allows to reach higher efficiency values of the machine, greater versatility in the realization of the hydraulic machine, lower wear in operation and which, considering the required durations of this type of machines, is translated into remarkable savings on manufacturing and maintenance costs.

A second and important aim of the invention is to realize hydraulic machines with axial cylinders which, operating in combination, performs a significant reduction in the overall dimensions, with a high overall displacement and efficiency performance at the high pressures and also at the high rotational regimes often combined with minimum displacements, as it occurs in closed-circuit hydraulic motors.

An additional aim connected to the previous technical problem is to realize versatile versions of a hydraulic machine, that is to say, having small overall dimensions and with the possibility to use both ends of the shaft of the machine or the hollow shaft, for the passage of technical means of the specific application.

Furthermore, an additional aim of the invention is to realize multiple couplings of hydraulic machines with axial cylinders which, also in the presence of limited space available for the machine, can be sized to suit the high power and/or limited dimensions requirements.

Finally a further part of the above-mentioned technical problem relates to the realization of a hydraulic machine which by means of even separate controls can have a greater versatility than the versatility of the displacement variation realized with one single inclinable pad.

### SUMMARY OF THE INVENTION

This technical problem is solved, according to the present invention, by a hydraulic machine with oscillating axial cylinders comprising: a plurality of oscillating axial cylinders, put in synchronous rotation between a first rotating element, which supports one end of the cylinder, bottom or piston, and a second rotating element, which supports the opposite end of the cylinder; each cylinder is connected to said rotating elements with a ball joint towards each of them; each ball joint is holed to allow the passage and the feeding/discharge through it of the hydraulic liquid; characterised in that it has at least the bottom or the piston connected to the respective rotating element with a ball joint having a spherical surface with a diameter equal to or greater than the cylinder bore.

A variant of a hydraulic machine with oscillating axial cylinders, comprising: a plurality of oscillating axial cylinders, put in synchronous rotation between a rotating flange, constituting the first rotating element, to which the bottoms of the cylinders are connected, and a rotating disc, constituting the second rotating element, to which stems of pistons are connected, which are movable within the respective cylinders; each bottom is connected with a ball joint to a respective connection pin with the rotating flange and each piston is connected with a ball joint to the respective connection stem with the rotating disc; the rotating disc being rotating against an inclinable plate, for the variation of the displacement of the hydraulic machine; and it has each ball joint consisting of a spherical connection between a holed ball, which is rigidly connected to a holed pin, to make the bottom of the cylinder oscillating with respect to the pin, or rigidly connected to a holed stem, to make the piston oscillating with respect to the holed stem; characterised in that in the case in which the diameter of the spherical surface is smaller than the bore, the bottom and/or the piston are made enbloc to enclose the respective holed ball in the contact of the spherical surface between them; at least one of them has, on the side facing the outside of the cylinder, a prismatic passage to allow for the introduction of the holed ball in a rotated position with respect to the final laying of mounting and working of the ball itself in the spherical connection between them.

In a specific embodiment of the oscillating axial cylinder: the piston is made by embossing the metal of which it is made directly on the spherical surface of the ball joint.

In a variant of an embodiment: a spherical seat of the spherical connection between the piston or bottom and holed ball has an edge in the bottom or in the head of the piston which releases the push of the pressure on the spherical connection with the holed ball.

A preferred embodiment of the piston: it has a ring seal placed in the external cylindrical surface of the piston in a backward position with respect to the head of the piston and in contact with the internal cylindrical surface of a sleeve constituting the liner of the oscillating axial cylinder.

In a preferred embodiment: the connection between holed balls and the respective holed pin or holed stem is realized by deformation of a deformable internal lip of the pin or of the stem by calking.

Furthermore, in a specific embodiment of a hydraulic machine according to the invention: a hydraulic device for controlling and commanding the displacement variation has a one-way double cylinder acting on the oscillating plate, through a connecting peg and a rocker fever placed between the peg and the pistons, to arrange a specific inclination of said plate and control the instantaneous displacement of the hydraulic machine in an intermediate position between the minimum and maximum displacement.

Moreover, in a more advantageous realization of a hydraulic device of control and command: said rocker lever being made with unequal arms for determining a different positioning of the peg and plate according to the specific one-way cylinder activated.

Furthermore, in a specific embodiment of the invention in a hydraulic motor, comprising two groups of oscillating axial cylinders, it has each oscillating axial cylinder of one group fed through the corresponding oscillating axial cylinder of the other group, in such a way as to use one single distributor on one side of the hydraulic motor.

Moreover, in an additional embodiment of a hydraulic machine with oscillating axial cylinders, comprising a machine body which houses a distributor of hydraulic liquid and of connection with a delivery branch and a discharge branch of said hydraulic circuit, which has, housed in said machine body, a group of oscillating axial cylinders, as previously described, and in which the rotating shaft is in common with other connected hydraulic machines put in rotation with the same rotating shaft, the hydraulic machines are thus made in a modular way, advantageously as pumps, in such a way as to operate as one single unit but on different hydraulic circuits with a specific control of displacement in each of them.

Furthermore, in a second embodiment, a hydraulic machine has the ball joint connected to the bottom of the sleeve of the oscillating axial cylinder and realizes the hydraulic sealing in a spherical seat housed on a rotating disc, constituting said first rotating element; the ball joint is subject to an annular clamp for sealing; a second rotating element is made up of a pad rotating synchronously with the rotating disc, by means of a constant velocity joint, which supports the pistons by means of a holed stem and a ball joint.

Moreover, in a third embodiment, a hydraulic machine has the ball joint, constituting the bottom of the sleeve of the oscillating axial cylinder, realizing the hydraulic sealing in a spherical head connected on a rotating disc, constituting said first rotating element; the ball joint is subject for sealing to an annular clamp, which acts on an external spherical annular section of the ball joint; a second rotating element is made up of a pad rotating synchronously with the rotating disc, by means of a constant velocity joint, which supports the pistons by means of a spherical head of the ball joint within them.

In a fourth preferred embodiment, a hydraulic machine has the ball joint, constituting the bottom of the sleeve of the oscillating axial cylinder, realizing the hydraulic sealing in a spherical head connected on a rotating disc, constituting said first rotating element; the ball joint is subject for sealing to an annular damp, which acts on a sleeve end spherical seat; the second rotating element is made up of a barrel rotating synchronously with the rotating disc, by means of a constant velocity joint, which realizes the closure of the oscillating axial cylinder, by means of a cylindrical hollow, coupled with a ball joint to the external diameter of the sleeve, which has a spherical surface of the ball joint having a greater diameter than the cylinder bore.

Furthermore, in a variant of the fourth embodiment, a hydraulic machine has two groups of oscillating axial cylinders; the cylinders of each group are opposed and rotating synchronously with the oscillating axial cylinders of the other opposite group; the feeding and discharge of the hydraulic liquid occurs from one single distributor on one of the two groups and the opposite group is fed through the opposed cylinders of the first group fed.

Finally, a specific variant of the fourth embodiment has the variability of displacement realized with inclinable plates on each group of oscillating axial cylinders; the control of the inclination of the plates occurs by means of movement rods operated synchronously and subject to a return force in the position of maximum inclination and, therefore, maximum displacement of the hydraulic machine, be it a pump or a motor.

Further characteristics and the advantages of the present invention, in the realization of a hydraulic machine with oscillating axial cylinders, will be clear from the following description of different embodiments of an improved oscillating axial cylinder inserted in the hydraulic machines which use it, given as a non-exhaustive example with reference to the enclosed sixteen drawing tables.

### SHORT DESCRIPTION OF THE DRAWINGS

FIG. 1 shows a schematic sectional view of a hydraulic machine according to the invention, here a variable displacement motor is shown in an intermediate displacement position between the minimum displacement and the maximum displacement;

FIG. 2 shows a schematic view in axial section of an oscillating axial cylinder of the type similar to that used in the hydraulic machine of FIG. 1;

FIG. 3 shows a schematic perspective and exploded view, in its components during assembly of an oscillating axial cylinder of FIG. 2 in which the bottom of the cylinder and the piston are made by the process of embossing directly on the holed ball, which constitutes the movable part of the ball joint present in them;

FIG. 4 shows a schematic hypothetical and perspective view of the oscillating axial cylinder with an exploded arrangement of the parts; the separate representation between the holed ball in the piston and in the bottom of the cylinder is hypothetical because the spherical seat present in the bottom and in the cylinder does not allow for assembly if the parts are in the position shown; the ball cannot be housed correctly if not by said construction by embossing or if there is no means for mounting or retaining it in its seat;

FIG. 5 shows a schematic view in axial section of an oscillating axial cylinder; of a type similar to that used in the hydraulic machine of FIG. 1, which, unlike the cylinder shown in FIG. 2, has a passage of introduction of the respective ball into its spherical seat in the bottom of the cylinder and into the spherical seat in the piston;

FIG. 6 shows a schematic perspective and exploded view, in its components during assembly of an oscillating axial cylinder of FIG. 5 in which the bottom of the cylinder and the piston have a prismatic passage for the introduction of the respective holed ball, which constitutes the movable part of the ball joint present in them; the two balls are shown aligned to the respective prismatic passage and ready for introduction into the respective spherical seat;

FIG. 7 shows a schematic perspective view of the oscillating axial cylinder with an exploded arrangement of the parts of FIG. 6, after the introduction of the holed balls into their respective seat in the bottom and in the piston; the ball is correctly housed in its seat and has the contact between it and the spherical seat complete towards the inside of the cylinder, while it has a contact limited to the arc of seat which is not occupied by the prismatic passage, used for its introduction into the seat, towards the outside of the cylinder, both in the seat of the bottom and in the seat of the piston;

FIG. 8 shows a schematic sectional view of a hydraulic machine according to the invention, here a variable displacement motor is shown, which is similar to the hydraulic motor of FIG. 1, in a maximum displacement position and provided with a balanced control between two hydraulic control signals of the displacement reduction;

FIG. 9 shows a limited schematic section on the plane IX of FIG. 8 of the balanced hydraulic control of the displacement reduction of the hydraulic motor represented in it;

FIG. 10 shows a schematic axial section of a hydraulic machine with a double pumping unit according to the invention: both units are made with variable displacement, and one unit has a limited variability, similarly to a motor, while the other unit has an equal or different variability on the basis of the overall displacement required from the machine; the feeding of one unit occurs through the other unit;

FIG. 11 shows a schematic axial section of a hydraulic machine with multiple and separate pump units, operated synchronously by the same through-shaft along the axis of the hydraulic machine; the pumps shown are adjusted to different displacements on the basis of the requirements of the hydraulic circuit of each pump, which is neither shown nor described as it is a use known in the art of the driving hydraulic circuits of vehicles;

FIG. 12 shows a schematic axial section on two right-angled planes concurrent on the axis of the shaft: here the hydraulic machine of FIG. 11 is shown with the lower part with respect to the shaft with the pumps adjusted to different displacements, similarly to the previous Figure, while the upper part shows the position of each of the oscillating supports of the rotating disc and oscillating with the stems of the pistons; in it there are also the levers of control from outside the machine body;

FIG. 13 shows a schematic side view of the hydraulic machine of FIGS. 11 and 12 with the operating levers of the oscillating supports;

FIG. 14 shows a schematic perspective view of a body of the hydraulic machine unit of the previous FIGS. 11-13;

FIGS. 15 and 16 show schematic perspective views of the oscillating support of variation of the displacement of the units of the multiple hydraulic machine of the previous FIGS. 11-13, which, by oscillating, allows the disc rotating with the stems and the pistons to realize the displacement variation;

FIG. 17 shows a schematic perspective view of a rotating flange keyed on the rotation shaft, provided with holed shaft ends for fixing the holed balls of the respective bottoms of the oscillating axial cylinders, as one can see in FIG. 1;

FIG. 18 shows a schematic perspective view of a rotating disc which is connected synchronously to the rotating flange of FIG. 7, which in its turn is rotating with the rotation shaft, and which is provided with holed stems for fixing the holed balls of the respective pistons present in the oscillating axial cylinders, as one can see in FIG. 1;

FIG. 19 shows a schematic axial section of a hydraulic machine with fixed displacement which adopts oscillating axial cylinders with a second embodiment; the hydraulic machine shown has a double group of oscillating and opposed axial cylinders with the hydraulic connection to the circuit through channels present in the partition between the two groups;

FIGS. 20, 21 and 22 show a schematic axial section of an oscillating axial cylinder of the hydraulic machine of FIG. 19, in the characteristic positions of top dead centre (TDC FIG. 20), piston midway of its stroke (FIG. 21) and bottom dead centre (BDC FIG. 22);

FIG. 23 shows a schematic axial section of a hydraulic machine with variable displacement which adopts oscillating axial cylinders with a third embodiment; the hydraulic machine shown has one single group of oscillating axial cylinders with the hydraulic connection to the circuit through channels present in the rotating disc which supports the bottoms of the oscillating axial cylinders;

FIGS. 24, 25 and 26 show a schematic axial section of an oscillating axial cylinder of the hydraulic machine of FIG. 23, in the characteristic positions of top dead centre (TDC FIG. 24), piston midway of its stroke (FIG. 25) and of bottom dead centre (BDC FIG. 26);

FIG. 27 shows a schematic axial section of a hydraulic machine with variable displacement which adopts oscillating axial cylinders with a fourth embodiment; the hydraulic machine shown has a double group of oscillating and opposed axial cylinders, on a central rotating disc which bears the ball joints of the hollow pistons; the hydraulic connection to the circuit occurs through channels present on a head of the casing of the machine; the feeding of the second group of the machine occurs by means of the first group;

FIGS. 28, 29 and 30 show a schematic axial section of an oscillating axial cylinder of the hydraulic machine of FIG. 27, in the characteristic positions of top dead centre (TDC FIG. 28), hollow piston midway of its stroke (FIG. 29) and bottom dead centre (BDC FIG. 30);

FIG. 31 shows a schematic axial section of the hydraulic machine with variable displacement of FIG. 27; the hydraulic machine, a motor with two groups of oscillating axial cylinders, is shown at the maximum displacement on a right-angled section plane with respect to FIG. 27; the feeding channels are present on the oscillating cylindrical surface towards the head of the casing and the distribution ports are present on the spherical ring surface of the group close to the channels; on the other spherical ring surface for supporting and guiding the opposite group of cylinders there is only a balancing hydraulic thrust;

FIG. 32 shows a simplified schematic axial section of the inclination control of the groups with oscillating axial cylinders of FIGS. 27 and 31;

FIG. 33 shows a schematic axial section of the hydraulic machine with variable displacement of FIGS. 27 and 31; here the hydraulic machine, with the two groups of oscillating axial cylinders, is shown with null displacement and with a right-angled section plane with respect to FIG. 27.

### DETAILED DESCRIPTION OF EMBODIMENTS OF THE INVENTION

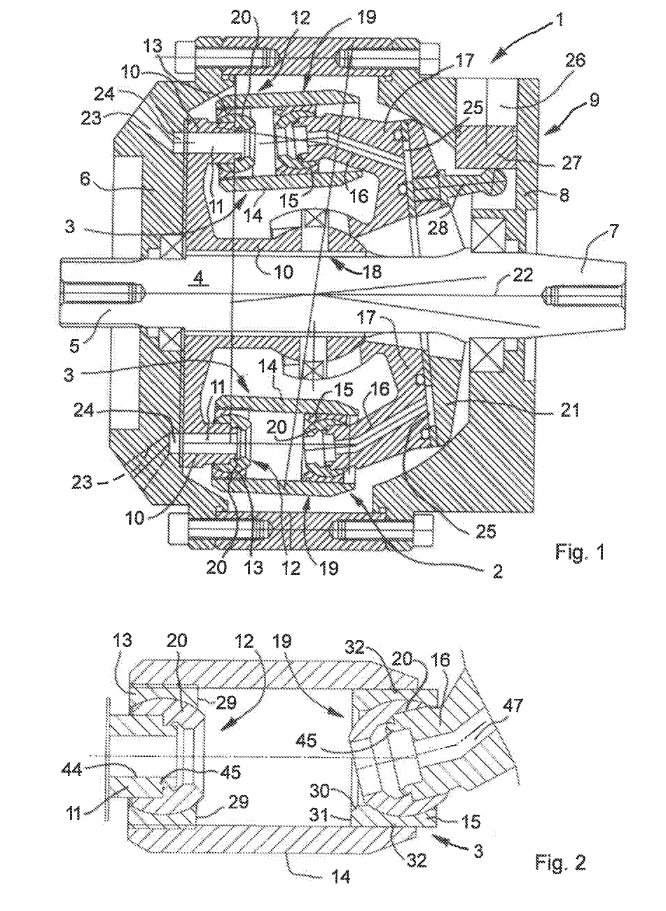

A hydraulic machine, in a first embodiment according to the invention, as one can see in FIG. 1, here made in a hydraulic motor 1, is provided with a group 2 of oscillating axial cylinders 3 which are put in synchronous rotation on a shaft 4 with end 5, on the side of the distributor cap 6, and end 7, on the side of the cap 8 with the control device 9 for controlling the displacement variation. The group 2 includes: a rotating flange 10, keyed and rotating with the shaft 4, which supports a plurality of holed pins 11 connected to a spherical connection 12 housed in the bottom 13 of an oscillating cylinder 3; a hydraulically sealing sleeve 14 is connected to the bottom in a stable way, constituting the liner of the oscillating cylinder; the rotating flange 10 constitutes a first rotating element. Within the sleeve 14 an axial piston 16 performs the reciprocating strokes following the change in the spatial positioning of the respective holed stem 16, which in its turn is connected in a stable way to a rotating disc 17 which, as said, is put in synchronous rotation with the rotating flange 10, by an axial ball joint 18 of synchronization between the flange and the disc, which are both rotating; the rotating disc 17 constitutes a second rotating element, in the connection between the axial piston 15 and holed stem 16 there is a spherical connection 19, similar to the spherical connection 12, and both free to rotate around their own axis, the bottom with the sleeve 14, and the axial piston 15, with respect to the fixed holed balls 20 of the spherical connections 12 and 19 on its own holed pin 11 or holed stem 16. Finally, the group 2 of oscillating axial cylinders 3 has the rotating disc 17 placed to slide, with liquid meatus of hydrostatic bearings of the known type, on an oscillating plate 21, on an axis coincident with said ball joint 18, in such a way as to determine with the inclined position of the oscillating plate 21, with respect to the axis 22 of the shaft 4, an instantaneous displacement depending on the inclination assumed by the oscillating plate 21. In operation said oscillating plate 21 being able to remain fixed in a given angular position, to determine a precise displacement, or to be taken to the maximum inclination or to the minimum inclination admissible, with the use of the displacement variation control device 9, a hydraulic motor not being able, as it is known in the art, to operate at a displacement close to null displacement.

Moreover, in FIG. 1 one can see the connecting ducts 23 of the hydraulic circuit, which feed a distributor 24 of the known type, to connect in operation the various oscillating axial cylinders 3 with one or the other of the ducts 23 for the delivery or the discharge of the hydraulic liquid. The holed pins 11 and the holed balls 20 enable the passage of the liquid from and towards the oscillating axial cylinder 3; moreover, the hydraulic liquid, through the holed balls 20 and the holed stem 16, feeds the hydrostatic bearings 25 present in the sliding contact between the rotating disc 17 and the oscillating plate 21. In the displacement variation control device 9 a one-way cylinder 26 is provided with a piston 27 which acts pushing on a peg 28, connected to the oscillating plate 21 to change its inclination upon change in the piloting pressure with which the one-way cylinder 26 is fed.

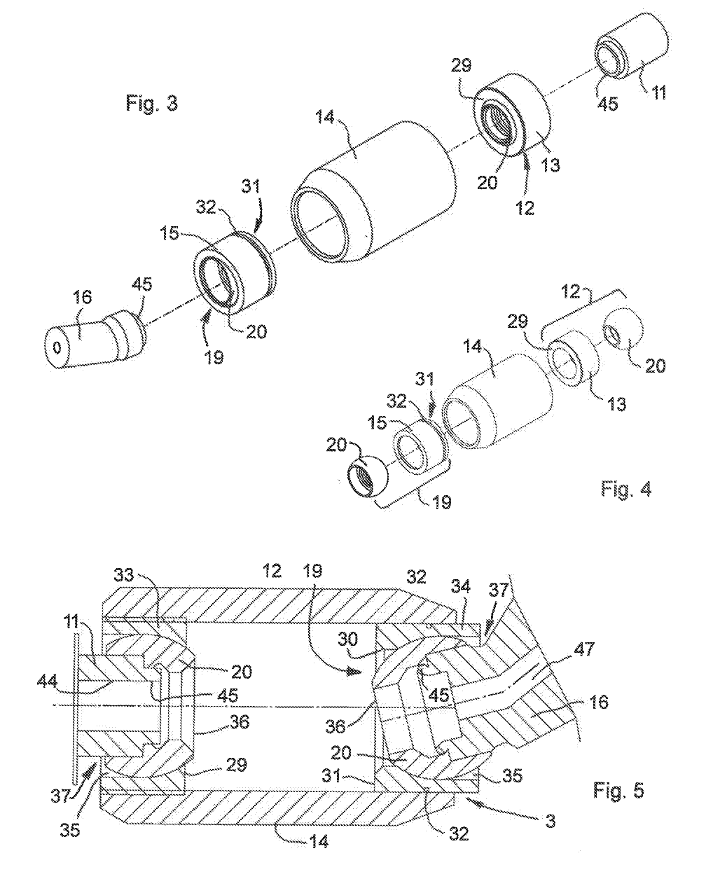

Moreover, in FIGS. 2 to 4 one can see a first embodiment of the oscillating axial cylinder 3 used in the group 2 of the hydraulic motor of FIG. 1. The spherical connection 12 in the bottom 13 is realized by embossing the bottom directly on the holed ball 20, in this way a minimum clearance is realized, which allows for the free rotation of the holed ball 20 with respect to the spherical internal surface present in the bottom 13; the sealing of the hydraulic liquid towards the cylinder is facilitated by the pressure of the liquid on the edge 29 of the spherical seat, which allows said edge to keep minimum the clearance and hydraulically sealed the underlying spherical surface although enabling its complete and free rotation. Moreover, also on the seal for the hydraulic liquid of the spherical connection 19, between the piston 15 and its holed ball 20, the sealing is facilitated by the shape of the undercut edge 30 present between the holed ball 20 and the head 31 of the piston 15. The pressure of the hydraulic liquid acts on the undercut edge 30 and on the head 31, facilitating the sealing between the piston and the liner of the cylinder by the thrust of the liquid on the head 31, wedging between the sleeve 14, the piston 15 and the undercut edge 30, pressing the edge itself towards the axis of the cylinder; the ring seal 32, present on the side of the piston, is placed backward in the stroke direction. Therefore, a simple sealing ring placed in its seat is sufficient to obtain a perfect sealing also at high pressures; moreover, the pressure of the liquid wedges between the wall of the liner and the external diameter of the piston in the head 31 of the piston, before the position of the sealing ring 32: the deformation towards the holed ball 20 of the undercut edge 30 makes the sealing between the holed ball and the internal spherical surface of the piston intended to stand the high pressures which a modern hydraulic machine reaches in operation; the backward position of the ring seal 32 enables a correct operation also in the presence of the strong hammering at every change in the connection of the oscillating axial cylinder 3 between the connection with the circuit branch under pressure and in discharge.

Moreover, in FIGS. 5 to 7 one can see a variant of an embodiment of the oscillating axial cylinder 3 in which a bottom 33 and a piston 34 are provided with a prismatic passage 35 of introduction of the holed ball 20 into the spherical seat of the respective spherical connection 12 or 19; the holed ball 20 has parallel planes 36 which allow for its introduction into the prismatic passage 35, made on the external edge 37 of the spherical seal present in the bottom 33 and in the piston 34. The holed ball 20, after being introduced as shown, is rotated and connected in a rigid way to the respective supporting end, be it a holed pin 11 or even a holed stem 18, advantageously by calking.

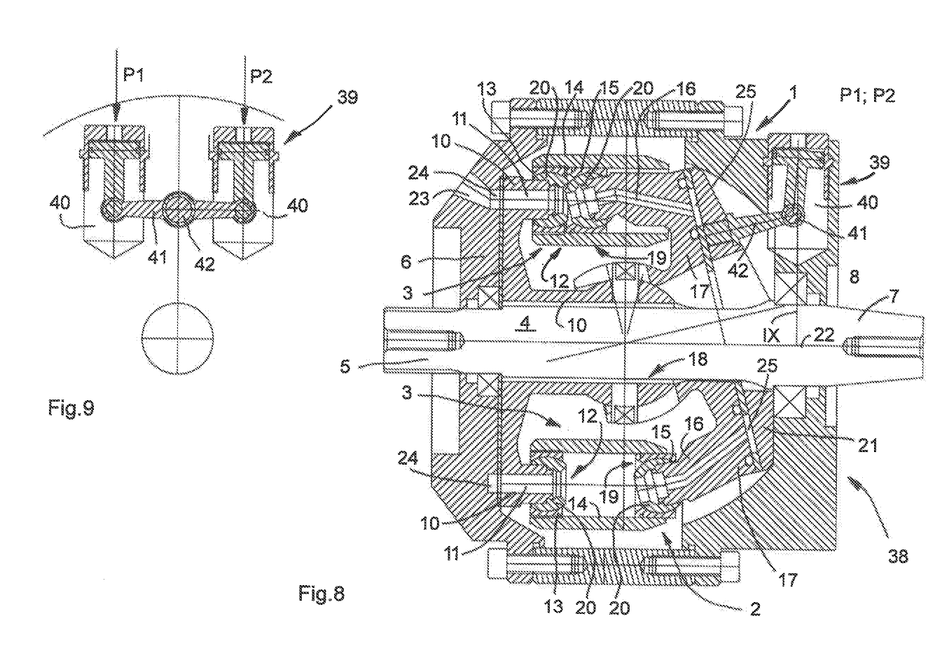

In the embodiment of the hydraulic motor of FIGS. 8 and 9, the hydraulic motor 38 is similar to the hydraulic motor 1 and, moreover, it has an improved control device 39 for controlling the displacement variation in which a one-way double cylinder 40 acts by means of a rocker lever 41 on the peg 42, using not a piloting pressure, but two pressures P1 and P2, with the arms of the rocker lever 41 having an identical length, with the possibility to select the effects of the two pressures and obtain a differentiated positioning of the peg 42 and, therefore, of the instantaneous displacement to which the hydraulic motor must be adjusted 38, or making the arms of the rocker lever 41 with a different length and acting with the same pressure P1=P2 alternatively on the double cylinder 40.

In FIGS. 17 and 18, in which one can see the shape of the rotating flange 10 and of the rotating disc 17, one can also see parts of them in which the holed pins 43, on the rotating flange shown, are made enbloc with the flange itself and have holes 44 of a diameter sufficient for the feeding of the single oscillating axial cylinder 3 of the group, thus said holed pins 43, like the holed pins 11, have a deformable lip 45, to be calked inside the holed ball 20. Similarly, the rotating disc 17 shown has holed stems 46, optionally made enbloc on the disc, which are also provided, like the holed stems 16, with a hole 47 for feeding the hydrostatic bearing 25 for balancing the thrusts and with a deformable lip 45, for the stable connection and hydraulic sealing of the holed stem with the corresponding holed ball 20. In the rotating disc 17 shown there are holes 47 of small diameter for feeding the pressure of the liquid to the hydrostatic bearing 25; however, said holes can be made with a greater diameter to enable the feeding of the cylinder through its hole.

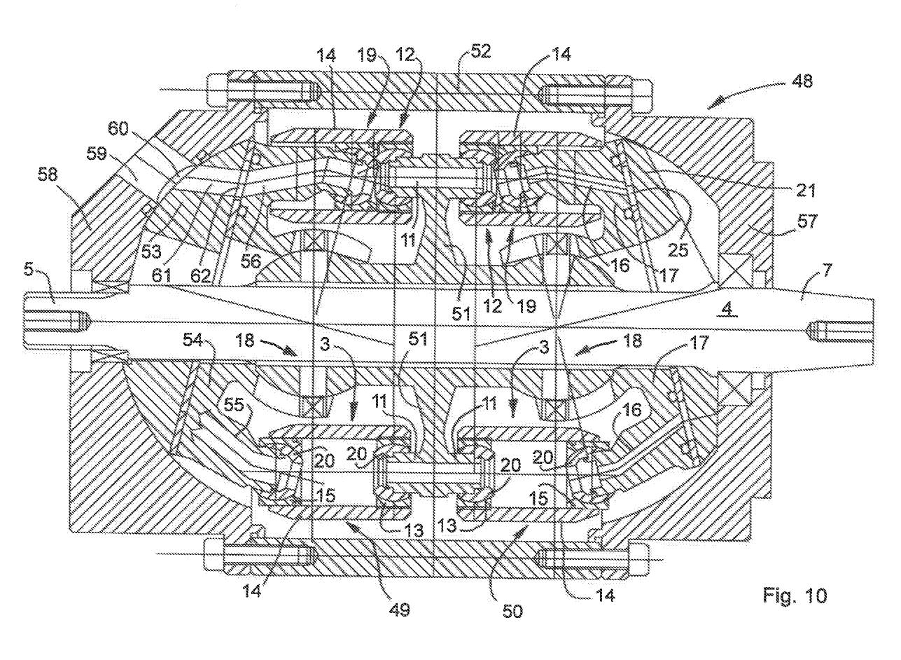

FIG. 10 shows, in axial section, a double hydraulic motor 48 subdivided with a first group 49, on the distribution side, and a second group 50, on the oscillating plate side, of oscillating axial cylinders 3, keyed and put in synchronous rotation on the through-shaft 4 with a double end 5 and 7, and in which the oscillating axial cylinders are made as described in the previous embodiments, with the same numerical references being used here. And wherein a rotating flange 51 has the opposed holed pins 11 of the two groups 49 and 50 of oscillating axial cylinders on opposite faces and is keyed on the shaft, centrally with respect to the casing 52 of the machine, in such a way as to keep a first group 49 towards a distributor plate 53, oscillating between a position of minimum inclination and of maximum inclination with the rotation on an axis coincident to the ball joint 18, for the connection and synchronization between the rotating flange 51 and a rotating disc 54, which in its turn is provided with holed stems 55 with a large hole 56 for the pistons 15 connected to them oscillating with said spherical connection 19. The feeding to the oscillating axial cylinder 3 of the second group 50 occurs through the holed pins 11 of the two bottoms 13 which are connected in an opposed way on the rotating flange 51. The hydraulic motor 48 having a double group of oscillating axial cylinders 3 is completed by a cap 57 on the displacement variation side, by means of the oscillation of the plate 17, as described for the previous Figures, and by a distributor cap 58, which has the feeding ducts 59, each of which is provided with expanded ports 60, for feeding at the various inclinations, as it is known for a rotating distributors, the channels 61 of the distributor plate 53, which feed the arched ports 62 of the distributor. The displacement variation with the control on the oscillating plate 21 or on the distributor plate 53, which, too, is oscillating, is controlled with a lever external to the casing 52, not shown, in axis to the axial ball joint 18 of the two groups, first group 49 and second group 50, of oscillating axial cylinders of the hydraulic motor; in fact, the plates 21 and 53 oscillate to increase or decrease the stroke of the pistons 15 within the sleeves 14 on the basis of the necessary and controlled displacement in operation. The rotational axes of the oscillation of the plates 21 and 53 must be parallel as well as passing for the centre of the axial ball joint 18 of the respective first 49 and second group 50.

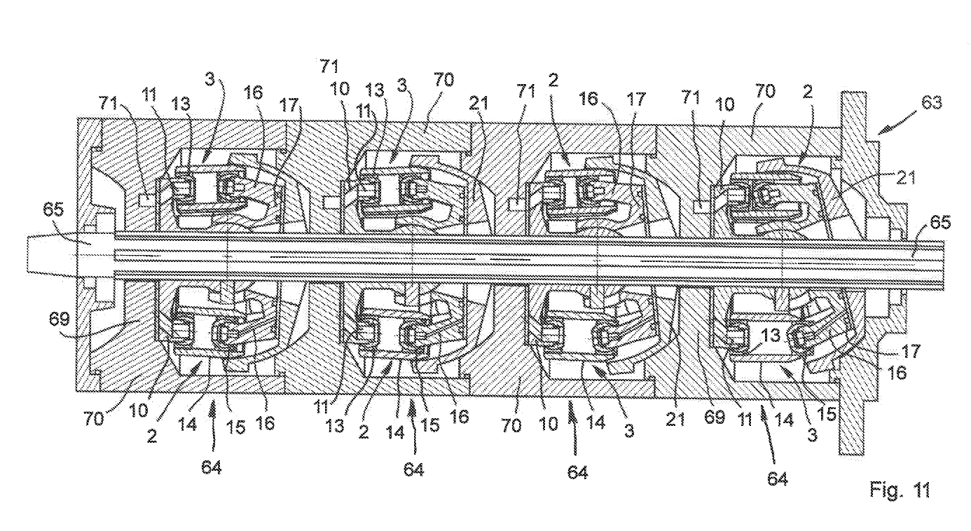

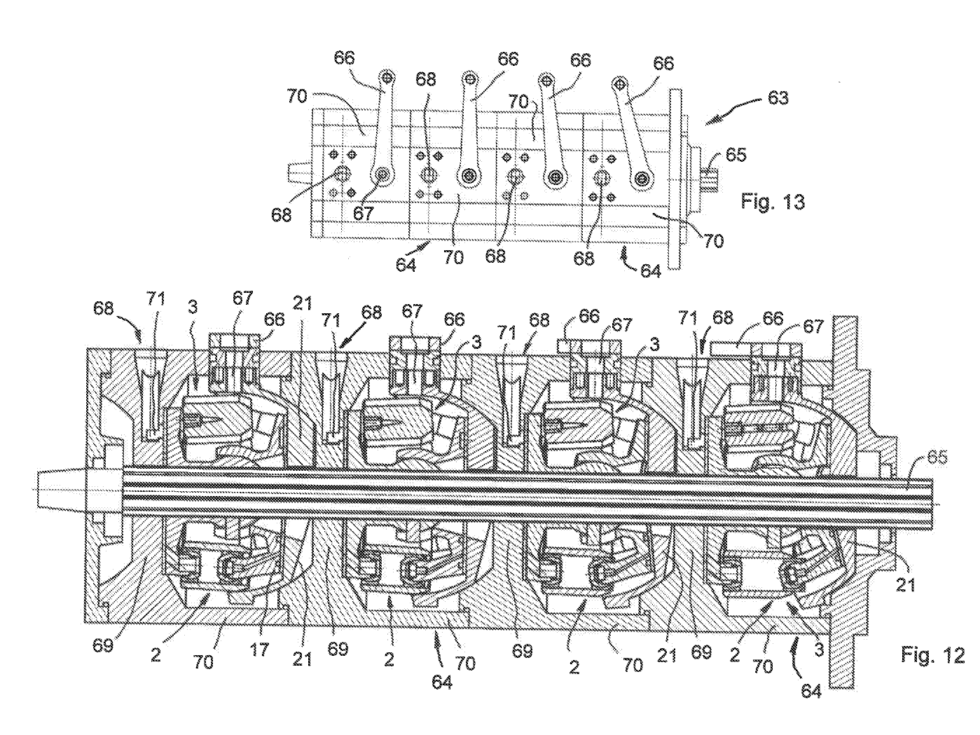

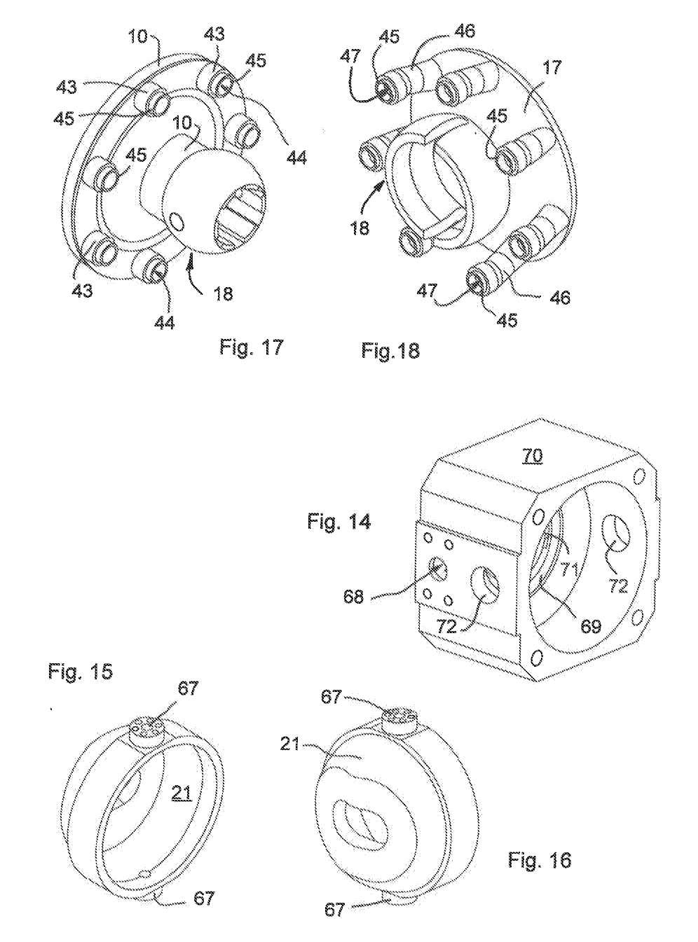

FIGS. 11 to 16 show a realization of a modular hydraulic machine 63 with the combination of four coaxial pumps 64, placed on the same operating through-shaft 65 which controls them simultaneously The oscillating axial cylinders 3 are made as in the previous Figures and identical or similar parts have the same numerical reference. Moreover, the oscillating plate 21, like in the hydraulic motor 48, with two groups of oscillating axial cylinders, is controlled in the oscillation by an external lever 66 which is connected to the coaxial pin 67 which is put to rotate on an axis passing through the centre of the axial ball joint 18, present in each coaxial pump 54. A distributor 68 is made in the bottom 69 of the modular machine body 70: the distributor has arched ports 71, of the known type, for feeding the holes of the holed pins 11 of each bottom 13, as described for FIG. 1. The oscillation of the oscillating plates 21 occurs in a guided condition by the pin 67, which in its turn is rotatably housed in the oscillation seat 72, whose position coincides with an axis passing through the rotational centre of the spherical ball joint 18, of connection in synchronous rotation between the rotating flange 10 and the rotating disc 17.

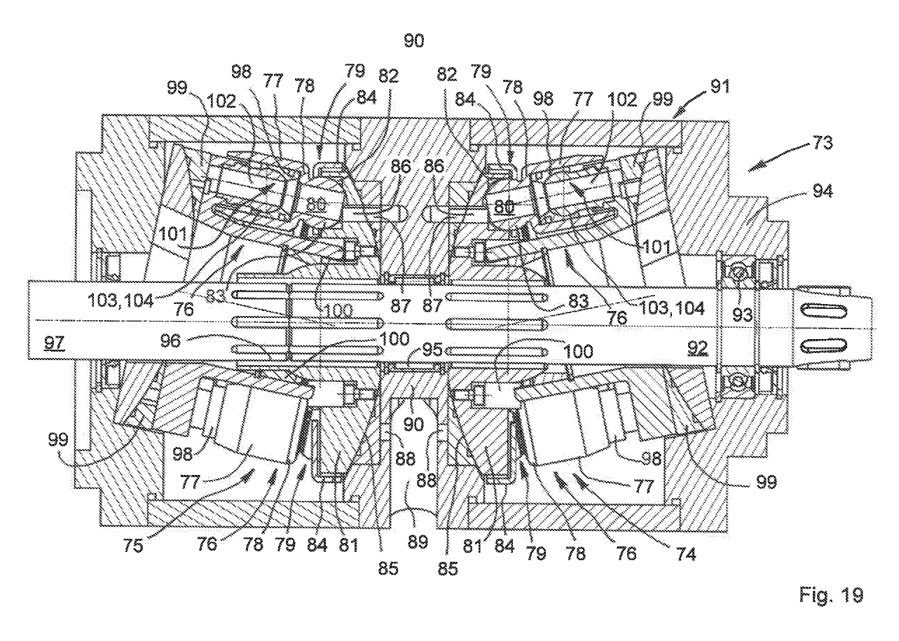

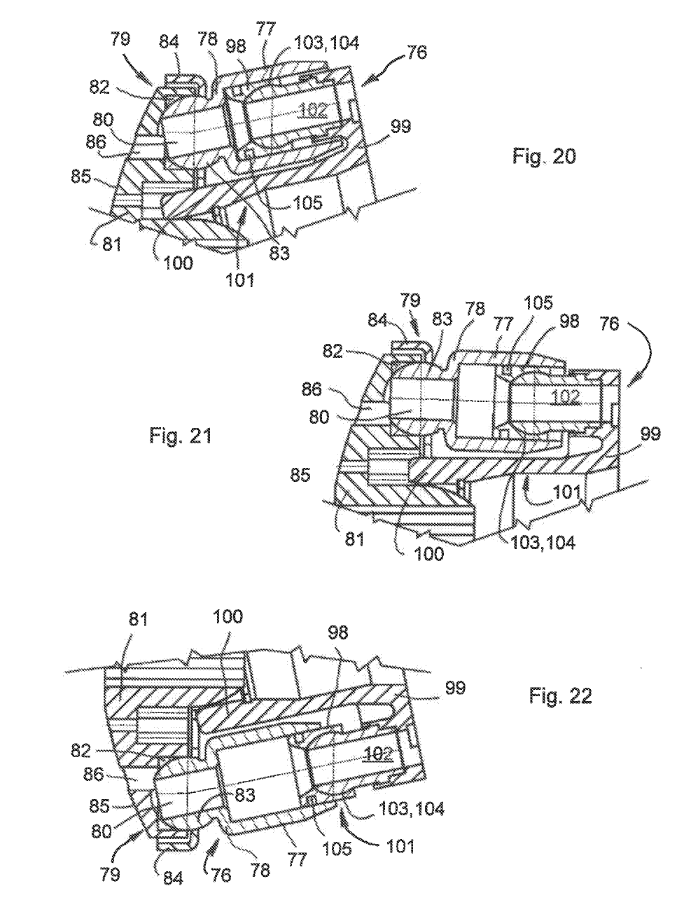

FIG. 19 shows a hydraulic pump 73 with a double group 74 and 75 of oscillating axial cylinders 76, in the second embodiment, and with fixed displacement; each cylinder sleeve 77 has a bottom 78 with a ball joint 70 and a hole 80 for the feeding and discharge of the cylinder with the hydraulic liquid. In FIGS. 20, 21 and 22 one can see in detail the parts making up the oscillating axial cylinder 78. A rotating disc 81 has the spherical seats 82 for housing the spherical head 83 of the joint 79, the spherical surface has a diameter equal to or greater than the cylinder bore; each spherical seat performs the hydraulic sealing against the spherical head 83 by the action of the annular clamp 84 which prevents its detachment. The distribution occurs on the spherical annular surface 85 of the rotating disc 81 through channels 86 in the disc and ports 37 in the corresponding spherical annular seat 88 on which the disc slides when it rotates; each spherical annular seat of each group of cylinders 74 and 75 is supported and in hydraulic connection with the delivery and suction channels 89 on the intermediate partition 90 of the casing 91 of the hydraulic pump 73. The rotating discs 81 are keyed and rotating synchronously with the driving shaft 92 supported by rolling bearings 93 in the cap 94 of the casing 95 in said intermediate partition 90. The pump 73, being modular, has, in the second group of cylinders 75, a connection with a driving joint 96 between the driving shaft 92 and an inserted shaft 97, which in its turn will drive another machine also of the non-hydraulic type, that is to say, also being able to be a motor actuating the set of the machines, not shown in FIG. 19. The pistons 98 of each oscillating axial cylinder 76 are supported and rotating synchronously on a pad 99 which is connected in the synchronous rotation with said rotating disc 81 through a constant velocity joint 100, which allows for the movement due to the different rotation inclination of the pad 99 with respect to the rotating disc 81 and with respect to the driving shaft 92; the pad 99 is guided and hydraulically supported like the rotating disc on a spherical annular surface. Each piston 98 is provided with a ball joint 101 made with the holed stem 102, which has a spherical end 103 coupled with a spherical seat 104 in said piston 98, here obtained by embossing the piston on the spherical end; moreover the piston 98 has a sealing ring 105 in the sliding contact between it and the internal cylindrical surface of the cylinder sleeve 77.

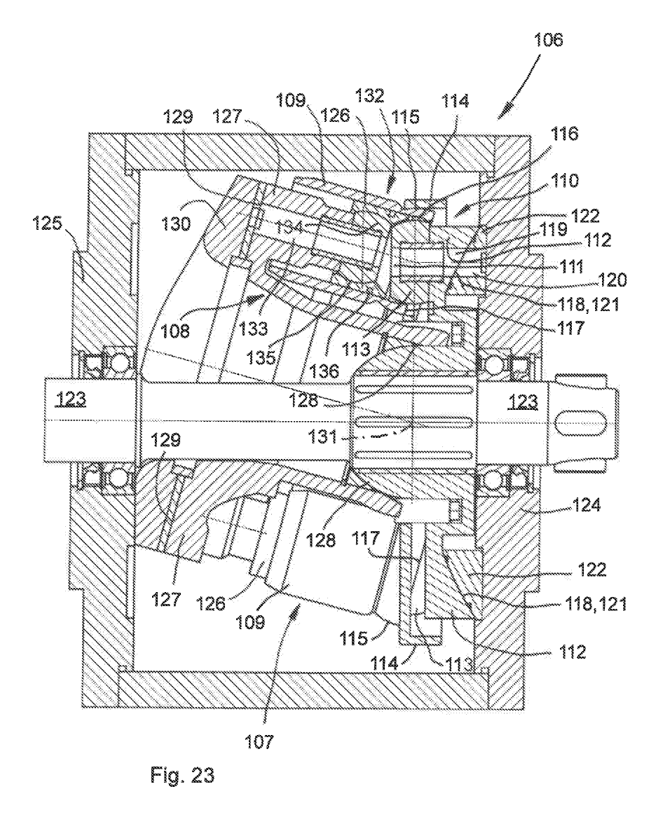

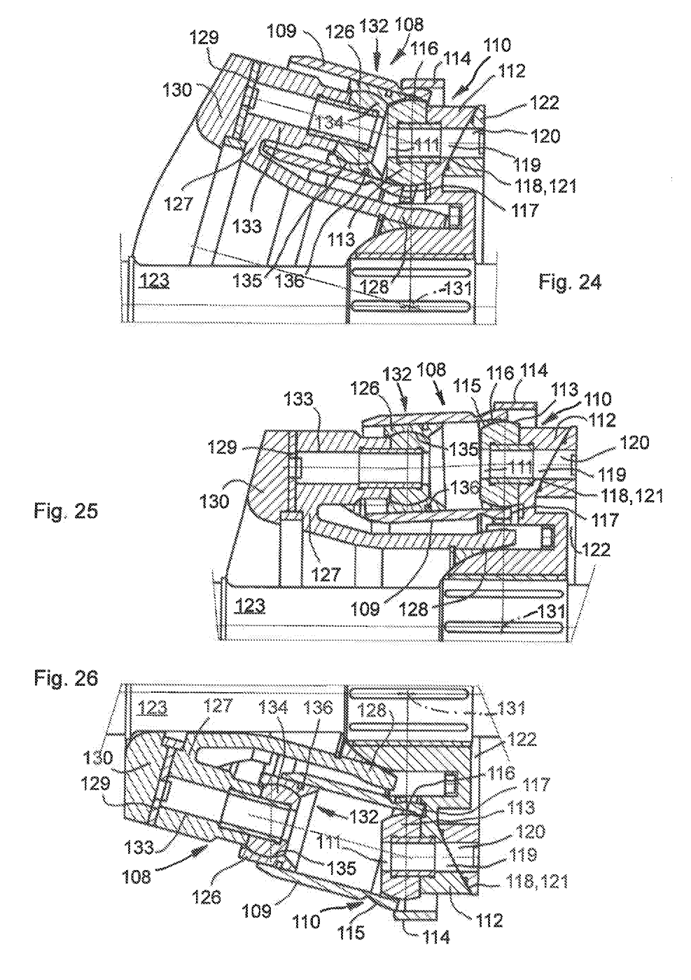

In the realization of FIG. 23 one can see a hydraulic motor 106 with a single group 107 of oscillating axial cylinders 108, in the third embodiment, and with variable displacement; each cylinder sleeve 109 has a ball joint 110, and a hole 111, for the feeding and discharge of the cylinder with the hydraulic liquid to constitute the complete bottom of the cylinder 108. In FIGS. 24, 25 and 26 one can see in detail the parts making up the oscillating axial cylinder 108. A rotating disc 112 supports in rotation the spherical heads 113 of the ball joint 110, the spherical surface has a diameter equal to or greater than the cylinder bore; each spherical head realizes the hydraulic sealing against the sleeve 109 by the action of the annular clamp 114, coupled with an external spherical annular section 115 of the sleeve 109, which prevents its detachment, and by the positioning of an internal sealing ring 116, embossed inside the sleeve in a specific cylindrical annular seat, in the end 117 of the sleeve 109, which realizes the internal annular spherical surface coupled on said spherical head 113. The distribution occurs on the spherical annular surface 118 of the rotating disc 112 through channels 119 in the disc and ports 120. shaped for the distribution, in the corresponding spherical annular seat 121, added with a distributor ring 122, on which the disc 112 slides when it rotates, carrying out the distribution of the hydraulic liquid from the suction and discharge ducts present in the cap 123, not shown in the Figure. The rotating disc 112 is keyed and rotating synchronously with the driving shaft 123 supported with rolling bearings in the cap 124 and in the opposite cap 125. The pistons 126 of each oscillating axial cylinder 108 are supported and rotating synchronously on a pad 127 which is connected in the synchronous rotation to said rotating disc 112 through a constant velocity joint 128, which allows for the movement due to the different rotation inclination of the pad 127 with respect to the rotating disc 112 with the driving shaft 123; the pad 127 is guided and hydraulically supported like the rotating disc on a flat annular surface 129, made and inclinable with the angles necessary for a hydraulic motor known in the art, on an oscillating plate 130, which in said angulation is hinged in correspondence of the intersection 131 between the rotation plane of the ball joints 110 and the axis of the driving shaft 123. Each piston 126 is provided with a ball joint 132 made with the holed stem 133 to which a spherical head 134 is connected, which in its turn is coupled with a spherical seat 135 in said piston 126, here obtained by embossing the piston on the spherical head; moreover, the piston 126 has a sealing ring 136 in the sliding contact between it and the internal cylindrical surface of the cylinder sleeve 109.

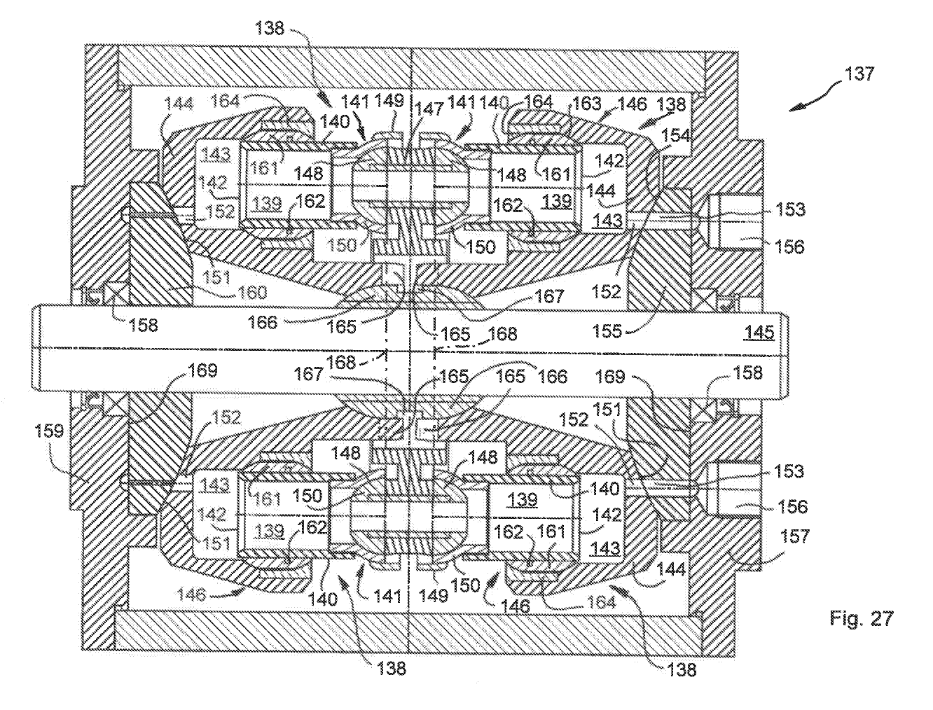

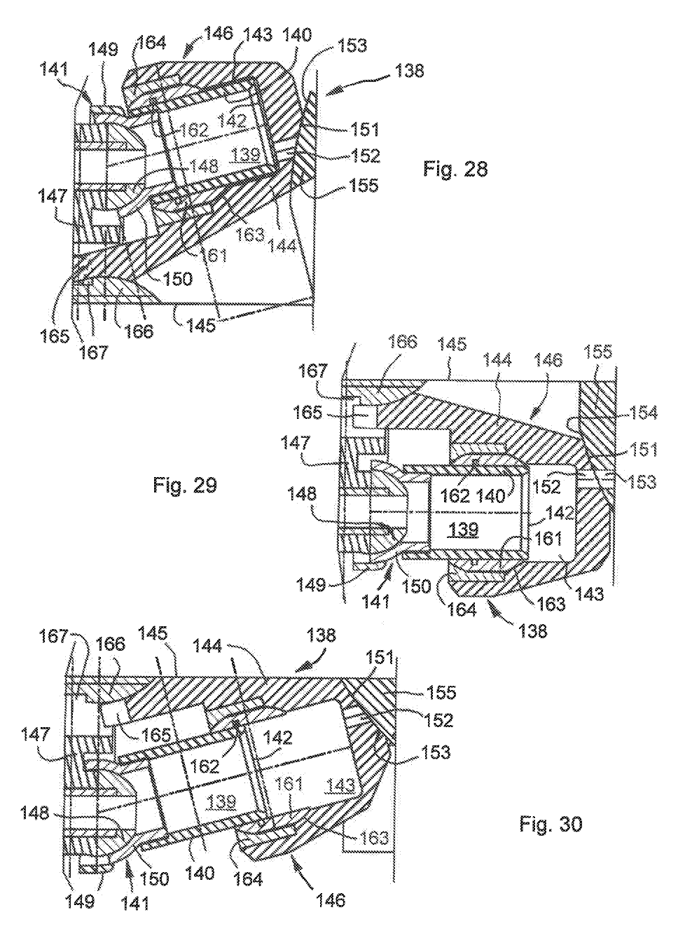

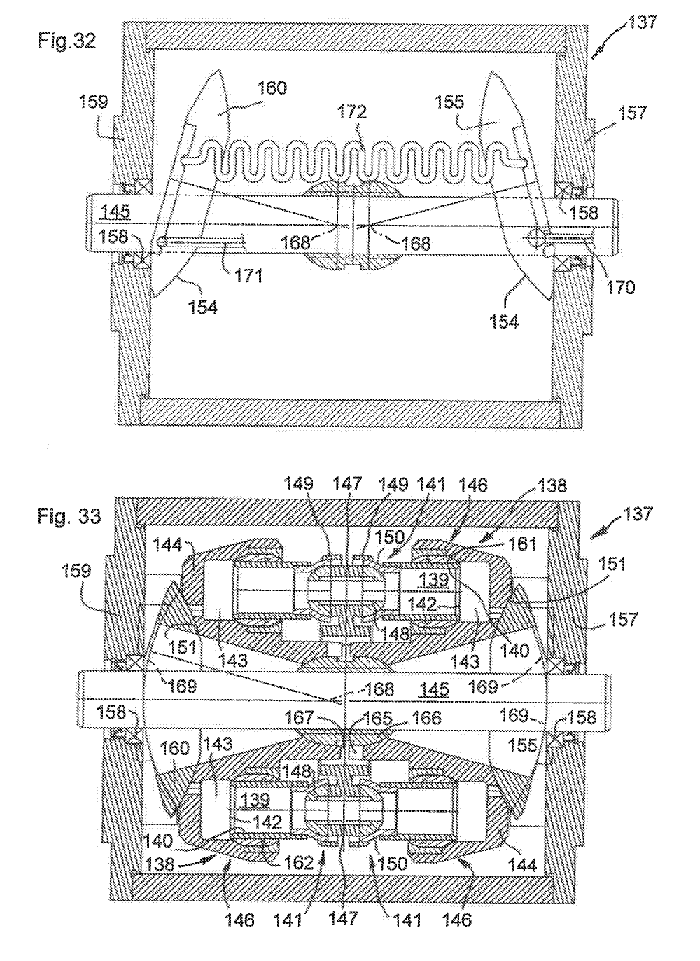

FIGS. 27 to 33 show a hydraulic machine 137, here in the version of a hydraulic motor, which adopts a fourth embodiment of an oscillating axial cylinder 138 comprising a hollow piston 139, in such a way as to consist of an oscillating sleeve 140 supported in oscillation by a ball joint 141 in the end of the oscillating sleeve, while on the opposite side the oscillating sleeve is completely open towards a cylindrical hollow 143, obtained in a rotating barrel 144 which rotates synchronously with the driving shaft 146, within which the opposite end 142 is movable. The end 142 of the oscillating sleeve is guided in the cylindrical hollow 143 by means of a ball joint 146, with a diameter of the spherical surface greater than the cylinder bore, and in the reciprocating motion it does not come into contact with the walls of the cylindrical hollow due to the sizing of the latter. A rotating disc 147 supports in rotation the spherical heads 148 of the ball joint 141, the spherical surface has a diameter equal to or greater than the cylinder bore; each spherical head realizes the hydraulic sealing against the oscillating sleeve 140 by the action of the annular clamp 149, coupled with a spherical seat in the end 150 of the oscillating sleeve and prevents its detachment. The distribution occurs on the spherical annular surface 151 of the rotating barrel 144 through channels 152 in the barrel and ports 153, shaped for the distribution, in the corresponding spherical annular seat 154, present on the inclinable plate 155, on which the barrel 144 slides when it rotates, carrying out the distribution of the hydraulic liquid from the delivery and return ducts 156 present in the cap 157, of FIG. 27. The rotating disc 147 is keyed and rotating synchronously with the driving shaft 145 supported by rolling bearings 158 in the cap 157 and in the opposite cap 159. Because of the balanced construction with respect to the non-compensated axial thrusts, the hydraulic machine 137 is made with a double series of oscillating axial cylinders 138 opposed on the two sides of the rotating disc 147; therefore, the side opposite to the cap 157 is made without distribution ports or ducts, that is to say, with an inclinable reaction plate 160, which can be inclined like the inclinable plate 155, which realizes the simple compensation of the hydraulic axial thrusts realizing the hydraulic machine 137 with a limited sizing of the roiling bearings 158, due to the absence of non-compensated axial thrusts.

The ball joint 146 is made with a holed bush 161 which is coupled with the oscillating sleeve 140, for its reciprocating sliding as a piston and has a sealing ring 162 between the holed bush and the sleeve; the holed bush is housed in a spherical seat 163 of the rotating barrel 144 and is held by a guiding and locking ring 164.

Each rotating barrel 144 is connected through a front constant velocity joint 165 to the rotating disc 147 and through it to the driving shaft 145. The connection of the rotating disc 147 to the driving shaft 145 occurs by means of a keying 166 with suitable driving seats 167 in the rotating disc of connection of the front constant velocity joint. Each inclinable plate 155, with the ducts, or reaction inclinable plate 160 is oscillating on the arched surface 169 with fulcrum in the intersection 168, between the axis of the driving shaft 146 and each centreline plane of the spherical heads 148; the arched surface has its centre in said intersection 168. Finally, the adjustment of the inclination of each inclinable plate 155 or 160 occurs under the action of a movement rod 170, for the inclinable plate 155, and a movement rod 171, for the oscillating plate 160; in opposition to the inclination motion, generated by the specific position imposed to said movement rods, with the sliding of the inclinable plates on the arched surface 169, there is the traction action with an elastic means 172, a traction spring, which adjusts displacement back to the maximum value, in the absence of contrary activation.

The operation of a hydraulic machine with oscillating axial cylinders, according to the invention, occurs by the specific shape of the adopted oscillating cylinders, as follows.

For the correct operation of an oscillating axial cylinder in the first embodiment, of an axial and oscillating 3 pumping cylinder, for a pump or for a motor, there must be the possibility to make up for the alignment differences which are generated between the holed pins 11 and the holed stems 16, the first being connected to the bottom 13 of the cylinder and the latter being connected to the piston 15 which performs evolutions in the sleeve 14, constituting the liner of the cylinder 3.

With operation, as one can see in the various Figures, the coaxiality between pins and stems is not realized in the development of the displacement with the reciprocating motion of the piston in the sleeve 14, therefore, a correction of the position of the piston with respect to the bottom in the cylinder is necessary for the correct operation of the mechanism, in motion the pressure which acts within the cylinder varies in a sudden way at every cycle from the delivery pressure, the hydraulic machine operation pressure, and the discharge pressure for the evacuation of the hydraulic liquid. This is translated into hammering actions between the members internal to the oscillating axial cylinder 3, in such a way as to rest in the same point of contact with an articulated joint of a type known in the art. With the articulated joint described in the invention the holed ball 20 is rigidly connected to the holed pin 11, in the spherical connection 12, thus it is rigidly connected to the holed stem 16, in the spherical connection 19. These ball joints are free to rotate on themselves, that is to say the bottom 13 and, therefore, the sleeve 14 can rotate freely with respect to the spherical surface of the holed ball 20 present in the spherical connection 12. Similarly the holed stem 16 and the holed ball 20, of the spherical connection 19, are rigidly connected to each other while the piston 15, with its own internal spherical surface, is free to rotate on the spherical surface of the holed ball 20; moreover, the piston 15, being in reciprocating motion within the sleeve 14, for the development of the necessary displacement, is also free to rotate with respect to the same sleeve 14. Therefore, in operation both the bottom 13 and sleeve 14 assembly and the piston 15 can adapt the position of the surface subject to contact superficial stresses, rotating and progressively providing for contact new spherical surface, in such a way as to distribute the possible wear over the whole contact surface and realize a much longer duration of the surface than that which would be obtainable with the joints in the bottom or in the piston known in the art.

In the spherical connection 12 or 19 the sealing to the pressure of the hydraulic liquid occurs by contact on the spherical surface and near the spherical seat edge 29 in the bottom 13 or the undercut edge 30 in the piston 15; the pressure which acts in the spherical crown of contact is limited to the crown in the bottom or in the piston between the internal diameter of the sleeve 14 and the free diameter in contact with the hydraulic liquid on the spherical surface. The surface on which said pressure acts is a minimum part of the surface directly exposed to the hydraulic liquid of the holed ball 20 and holed pin 11 or holed stem 16, therefore, the contact action occurs with limited forces, to the advantage of the duration of the spherical connection without any damage also in the presence of the hammering at every cycle.

Moreover, in the piston 15 according to the invention there is, on its external cylindrical surface, a ring seal 32, whose backward position, in the direction of the stroke of the piston in the sleeve 14, enables correct operation also in the presence of the strong hammering at every connection variation of the oscillating axial cylinder 3, between the connection with the circuit branch under pressure and in discharge. In fact, the hydraulic liquid wedging between the piston and the sleeve 14, besides loading radially the spherical connection 19, considerably reduces the sliding contact between the cylindrical surface of the piston and the internal cylindrical surface of the sleeve; said contact reduction considerably increases the duration of the piston inside the sleeve 14, similarly to the lift effect of the hydrostatic bearings.

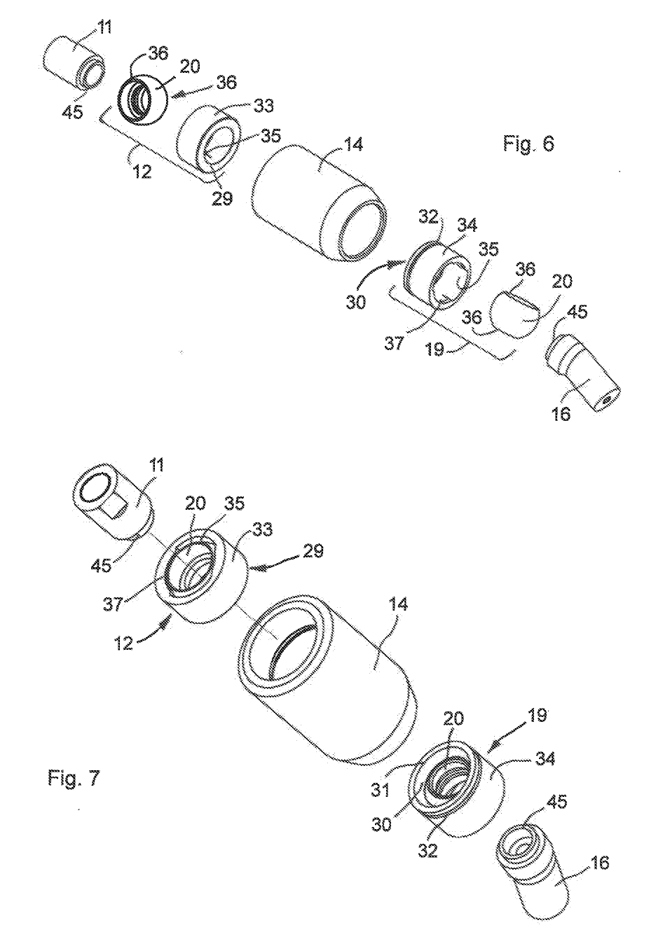

Furthermore, the mounting of the holed ball 20 within the spherical seat in the bottom 13 or in the piston 15 occurs, advantageously, in addition to embossing, also by the introduction of the holed ball 20 in a rotated position, by a right angle, passing with the parallel planes 36 of said holed ball in the prismatic passage 35, made in the bottom 33 or in the piston 34. After the introduction, as one can see in FIGS. 6 and 7, the holed ball is rotated in the correct position and then is rigidly connected to the holed pin 11 or to the holed stem 16.

In the operation of the improved realizations of oscillating axial cylinder, second embodiment 76 and third embodiment 108, the constitution of the described ball joints is improved in the shape of the ball joint of the bottom of the cylinder. In particular, in the second embodiment the spherical head 83 of the joint 79, being made enbloc with the cylinder sleeve 77, is extremely simple in construction and its sealing, in the spherical seat 82 of said joint 79, added in the rotating disc 81, is improved with the axial thrust of the pressurized liquid and simplified in assembly with the annular clamp 84, in such a way as to make assembly simple as well.

Moreover, the third embodiment 108 of an oscillating axial cylinder has a ball joint 110 made with two spherical surfaces of the spherical seat in the end 117 of the sleeve 109, with simple external working, to shape the sleeve with the external spherical annular section 115 and with the insertion, into a specific internal cylindrical annular seat, in the end of the sleeve, of an internal sealing ring 116, which is kept into contact with the spherical head 113 by an annular clamp 114. The axial thrusts of the pressurized liquid in this case weigh completely on the spherical head 113 and on the opposite side on the piston 126 and spherical head 134 of the ball joint 132 in the piston, thus minimizing the axial thrusts on the internal sealing ring 116 which maintains, in operation, the contact with the spherical head 113 of the joint 110 for the necessary hydraulic sealing.

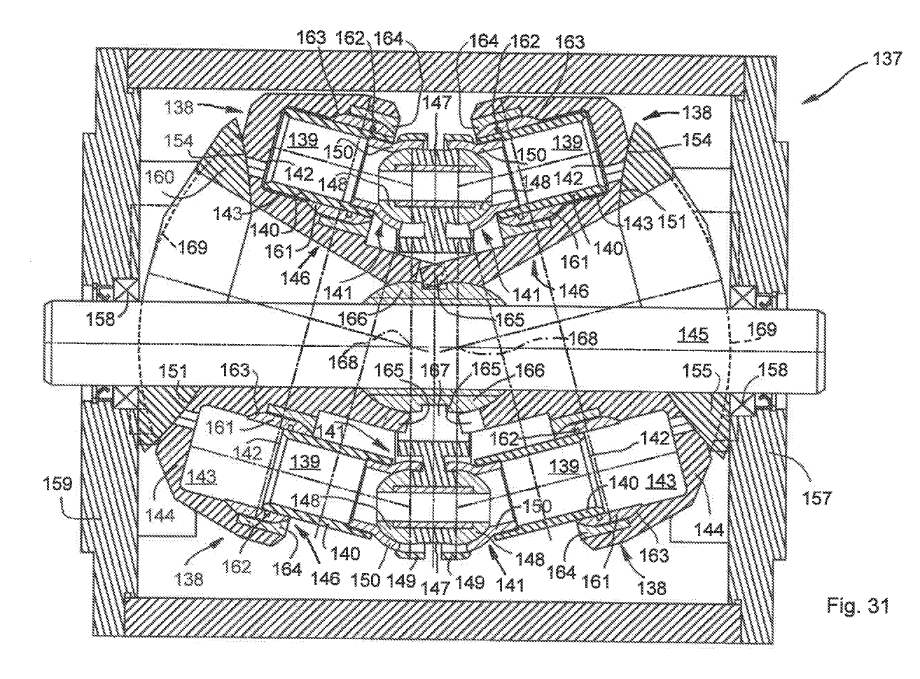

In the fourth embodiment the oscillating axial cylinder 138 is always guided in the reciprocating motion between the rotating disc 147, which guides in rotation the ball joint 141 in the synchronous rotary motion with the driving shaft 145, and the cylindrical hollow 143, which substantially acts as a cover for the oscillating sleeve 140, which in its turn is coupled with said rotating disc 147 with the ball joint 141, and towards the cylindrical hollow 143 with the ball joint 146. This embodiment allows to minimize the axial thrusts on the component parts, for the only purpose of realizing the sealing and for the constancy of the contacts in the ball joints, because the column of pressurized liquid is contained between said cylindrical hollow 143 and the rotating disc 147, which, in the special configuration of FIGS. 27-33, also comprises the opposite oscillating axial cylinder 139, in such a way as to realize one single column of pressurized liquid between the two opposing cylindrical hollows. By this embodiment of an oscillating axial cylinder one can make hydraulic machines with a single or double group of oscillating axial cylinders, as in the Figures, both in the form of a pump and in the form of a motor, which is shown here. In the specific embodiment of a hydraulic pump said inclinable plates 155-160 being able to be adjusted with the inclinations visible in FIGS. 31, maximum displacement, and 33, null displacement, but precisely for the use as a pump the same inclination is adjusted to negative for the necessary possible inversion for hydraulic pumps. Moreover, in the specific embodiment of a hydraulic motor the adjustment to zero of FIG. 33 corresponds—in the necessary use—to idling, that is to say, to the free rotation of the members connected to the shaft 145. Finally the control of the inclination of the inclinable plates 155 and 160, which can be controlled separately, but it is much more useful and advantageous to control them synchronously in such a way as to keep balanced with respect to the axial thrusts the architecture of the hydraulic machine, be it a pump or a motor.

The advantages of a hydraulic machine with oscillating axial cylinders according to the invention can be summarized as follows.

In fact, the greatest advantage in the realization of the described oscillating axial cylinders 3 lies in the possibility of miniaturizing the overall dimensions of the machine parts, that is to say, in the possibility of making hydraulic machines, both pumps and motors, which exploit much better than in the prior art the ratio between displacement and external dimensions of the machine; this, in the realization of the above-described invention, is translated into hydraulic machines which realize significant displacements with small overall dimensions and with very limited radial sizes. An example is given by the possibility of making a motor where two groups of oscillating axial hydraulic cylinders operate with the same distributor and the overall dimensions limit the external diameter of the hydraulic machine, in such a way as to make possible applications which require this feature. Moreover, the reduction in the diameters, at which the oscillating axial cylinders work, realizes a decrease in the centrifugal actions generated by the rotational speed on them.

Said advantages are very marked when one must realize a simultaneous multiple control of hydraulic machines, as one can see in the FIGS. 15-17, the modularity with which it is possible to make every single machine, here advantageously pumps, allows to combine them on one single driving shaft. Each pump 64 can be connected to a different hydraulic circuit, or an independent part of a hydraulic circuit, and is controlled in the displacement variation by an external action which can be a simple mechanical lever 66, which is shown, or even with complex drives acting on the lever. With the connection on one single through-shaft 65, the pumps 64 operate independently, but they do not require expensive gear couplers, as it occurs, for example, to operate the wheels of self-propelled machines with the necessary corrections for their steering in the motion of the vehicle.

Further important advantages are made possible with the embodiments of the oscillating axial cylinders 139, 108 end 76 for the simplification in the construction of the ball joint 141, 110 and 79 of oscillation of the corresponding sleeve 140, 109 and 77, as described above, which allows to significantly reduce construction costs, always maintaining operating safety and the reduction of wear due to the friction between the parts, that is to say in the final analysis, realizing hydraulic machines with a considerable improvement of the ratio between useful parameters such as power and received/transmitted torque, operating pressure, extension of the displacement variability towards the reduction of the overall external dimensions of the hydraulic machines, be they pumps or motors, with one or two rotating groups of oscillating axial cylinders.

Obviously, in the realization of a hydraulic machine with oscillating axial cylinders, as described above, a person skilled in the art, for the purpose of meeting specific and contingent requirements, can make several changes, all included in the protection scope of the present invention as defined by the following claims. Thus, although less conveniently, the housing of the holed ball 20 in its spherical seat in the bottom or in the piston can occur by introducing it by means of an edge present only on the side internal to the cylinder; axial locking means can be provided added or deformed on the edge on the side external to the cylinder in the bottom or in the piston.

Moreover, the realization of the hydraulic machines is independent of the fact that the groups of oscillating axial cylinders are associated on the side of the bottom or on the side of the piston or of the hollow piston. Furthermore, in the realization of two groups of oscillating axial cylinders in the same hydraulic machine, they can be associated with the reduction of the diameter of the driving shaft between the first group in line by mechanical connection with the user or external motor and the second group, thus realizing a controlled reduction of the external diameter of the driving shaft, to obtain a controlled twist oscillation and realize noise reduction also with small delay angles in the rotation between the first and the second group.

1. A hydraulic machine with oscillating axial cylinders comprising:
a plurality of oscillating axial cylinders, put in synchronous rotation between a first totaling element, which supports one end of the cylinder, bottom or piston, and a second rotating element, which supports the opposite end of the cylinder,
wherein each cylinder is connected to said rotating elements with a ball joint towards each of them,
wherein each ball joint is holed to allow for the passage and the feeding/discharge through it of the hydraulic liquid,
wherein at least the bottom or the piston is connected to the respective rotating element with a ball joint having spherical surface with a diameter equal to or greater than the cylinder bore, and
wherein the end of the cylinder has a ball joint, with an external spherical annular section at the end of the cylinder sleeve on which act an annular clamp, coupled to the external spherical annular section of the sleeve, which prevents its detachment.

2. A hydraulic machine with oscillating axial cylinders, comprising:
a plurality of oscillating axial cylinders, put in synchronous rotation between a rotating flange, constituting the first rotating element, to which the bottoms of the cylinders are connected, and a rotating disc constituting the second rotating element, to which the stems of pistons movable within the respective cylinders are connected,
wherein each bottom is connected with a ball joint to a respective pin of connection to the rotating flange and each piston is connected with a ball joint to the respective stem of connection to the rotating discs,
wherein the rotating disc being rotating against an inclinable plate, for the variation of the displacement of the hydraulic machine,
wherein it has each ball joint made up of a spherical connection between a holed ball, which is rigidly connected to a holed pin, to make the bottom of the cylinder oscillating with respect to the pin, or rigidly connected to a holed stem, to make the piston oscillating with respect to the holed stem,
wherein in the case in which the diameter of the spherical surface is smaller than the bore, the bottom and/or the piston are made enbloc to enclose the respective holed ball in the contact of the spherical surface between them, and
wherein at least one of them has, on the side facing the outside of the cylinder, a prismatic passage to allow for the introduction of the holed ball in a rotated position with respect to the final laying of mounting and working of the ball in the spherical connection between them.

3. A hydraulic machine, according to claim 1, wherein the piston is made by embossing the metal of which it is made directly on the spherical surface of the joint.

4. A hydraulic machine, according to claim 2, wherein a spherical seat of the spherical connection between the piston or bottom and the holed ball has an edge in the bottom or in the head of the piston which releases the thrust of the pressure on the spherical connection with the holed ball.

5. A hydraulic machine, according to claim 2, wherein it has a ring seal placed in the external cylindrical surface of the piston in a backward position with respect to the head of the piston and in contact with the internal cylindrical surface of a sleeve constituting the liner of the oscillating axial cylinder.

6. A hydraulic machine, according to claim 2, wherein the connection between holed balls and the respective holed pin or holed stem is realized by deformation of a deformable internal lip of the pin or of the stem by calking.

7. A hydraulic machine, according to claim 1, further comprising a hydraulic device for controlling and commanding the displacement variation, the hydraulic device comprising a double one-way cylinder acting on the oscillating plate, through a connecting peg and a rocker lever placed between the peg and the pistons, to arrange a specific inclination of said plate and control the instantaneous displacement of the hydraulic machine in an intermediate position between minimum and maximum displacement.

8. A hydraulic machine, according to claim 1, wherein said rocker lever is made with unequal arms, to determine a different positioning of the peg and plate according to the specific one-way cylinder actuated.

9. A hydraulic machine, according to claim 1, wherein a hydraulic motor, comprising two groups of oscillating axial cylinders, has each oscillating axial cylinder of one group fed through the corresponding oscillating axial cylinder of the other group, in such a way as to use one single distributor on one side of the hydraulic motor.

10. (canceled)

11. A hydraulic machine, according to claim 1, wherein the ball joint is connected to the bottom of the sleeve of the oscillating axial cylinder and realizes the hydraulic sealing in a spherical seat housed on a rotating disc, constituting said first rotating element,
wherein the ball joint is subject to an annular clamp for sealing, and
wherein a second rotating element is made up of a pad rotating synchronously with the rotating disc, by means of a constant velocity joint, which supports the pistons by means of a holed stem and a ball joint.

12. A hydraulic machine, according to claim 1, wherein the ball joint, constituting the bottom of the sleeve of the oscillating axial cylinder, realizes the hydraulic sealing in a spherical head connected on a rotating disc, constituting said first rotating element,
where the ball joint has a double spherical surface comprising an internal spherical surface and an external spherical surface, and is subject for sealing to an annular clamp, which acts on an external spherical annular section of the ball joint, and
wherein a second rotating element is made up of a pad rotating synchronously with the rotating disc, by means of a constant velocity joint, which supports the pistons by means of a spherical head of the ball joint.

13. A hydraulic machine, according to claim 1, wherein the ball joint constituting the bottom of the sleeve of the oscillating axial cylinder realizes the hydraulic sealing in a spherical head connected on a rotating disc, constituting said first rotating element,
wherein the ball joint has a double spherical surface comprising an internal spherical surface and an external spherical surface, and is subject for sealing to an annular clamp, which acts on a sleeve end spherical seat, and
wherein the second rotating element is made up of a barrel rotating synchronously with the rotating disc, by means of a constant velocity joint, which realizes the closure of the oscillating axial cylinder, by means of a cylindrical hollow, coupled with a ball joint to the external diameter of the sleeve, which has a spherical surface of the ball joint having a greater diameter than the cylinder bore.

14. A hydraulic machine, according to claim 13, wherein there are two groups of oscillating axial cylinders,
wherein the cylinders of each group are opposed and rotating synchronously with the oscillating axial cylinders of the other opposite group, and
wherein the feeding and discharge of the hydraulic liquid occurs from one single distributor on one of the two groups and the opposite group is fed through the opposed cylinders of the first group fed.

15. A hydraulic machine, according to claim 14, wherein the displacement variability is realized with inclinable plates on each group of oscillating axial cylinders, and
wherein the control of the inclination of the plates occurs by means of movement rods actuated in a synchronous way and subject to a return force in the position of maximum inclination and, therefore, of maximum displacement of the hydraulic machine, be it a pump or a motor.

16. A hydraulic machine with oscillating axial cylinders, comprising:
a machine body which houses a distributor of hydraulic liquid and connected to a delivery branch and to a discharge branch of a hydraulic circuit, and comprising a group of oscillating axial cylinders housed in the machine body,
wherein a rotating shaft is in common with other hydraulic machines, connected and put in rotation with the same rotating shaft the hydraulic machines being thus made in a modular way, and in such a way as to operate as one single unit but on different hydraulic circuits with a specific control of displacement in each of them.
